(19) United States
(12) Patent Application Publication
(10) Pub. No.: US 2013/0192434 A1
(43) Pub. Date: Aug. 1, 2013

(54) METHOD FOR PRODUCING CARBON FIBER AGGREGATE, AND METHOD FOR PRODUCING CARBON FIBER-REINFORCED PLASTIC

(71) Applicants: Takafumi Hashimoto, Nagoya-shi (JP); Hiroki Ninomiya, Iyo-gun (JP); Eisuke Wadahara, Nagoya-shi (JP); Masaaki Yamasaki, Nagoya-shi (JP)

(72) Inventors: Takafumi Hashimoto, Nagoya-shi (JP); Hiroki Ninomiya, Iyo-gun (JP); Eisuke Wadahara, Nagoya-shi (JP); Masaaki Yamasaki, Nagoya-shi (JP)

(73) Assignee: TORAY INDUSTRIES, INC, Tokyo (JP)

(21) Appl. No.: 13/878,449

(22) PCT Filed: Dec. 21, 2011
(86) PCT No.: PCT/JP2011/079625

§ 371 Date: Apr. 9, 2013

(30) Foreign Application Priority Data
Dec. 24, 2010 (JP) 2010-287883

(51) Int. Cl. B26D 3/00

(52) U.S. Cl. CPC B26D 3/00
USPC 83/13

(57) ABSTRACT

A method of producing a carbon fiber aggregate cutting an edge material of a carbon fiber base material composed of carbon fibers to obtain a cut piece, and forming the cut piece into a web and/or into a nonwoven fabric to obtain a carbon fiber aggregate.

### TECHNICAL FIELD

This disclosure relates to recycling a cut piece of the edge material of the carbon fiber base material, generated in a process of producing a carbon fiber-reinforced plastic (CFRP), into a carbon fiber aggregate and/or a carbon fiber-reinforced plastic. More concretely, the disclosure relates to a method of producing a carbon fiber aggregate and a carbon fiber-reinforced plastic and recycling the edge material of the carbon fiber base material into a CFRP having high mechanical properties.

### BACKGROUND

A fiber-reinforced plastic (FRP) comprising reinforcing fibers and a matrix resin is broadly employed as a material to produce a part applied for various uses such as airplanes, automobiles, ships, windmills or sporting goods, because it is excellent in mechanical properties, lightness in weight, corrosion resistance, etc. Although organic fibers such as aramide fibers or high-strength polyethylene fibers, and inorganic fibers such as carbon fibers, glass fibers or metal fibers are used as reinforcing fibers, for uses requiring high mechanical properties, carbon fibers are frequently employed. Since a carbon fiber-reinforced plastic (CFRP) using carbon fibers is excellent in strength, stiffness, lightness in weight and stability, it has become one of the main materials used in aerospace fields requiring high performance, and uses are expected to further increase in the future. Further, uses also for automobiles, windmills for wind power generation, etc. are expected to greatly increase in the future and, therefore, the amount of production of CFRP is expected to drastically increase in the future.

As a method of producing a CFRP, a process for using a so-called “prepreg,” which is prepared by being impregnated by a resin into carbon fibers in advance, is well known. In particular, in a so-called “autoclave molding process” wherein a thermosetting resin prepreg such as a so-called “unidirectional prepreg” prepared by being impregnated by a thermosetting resin into a sheet arranged with spread carbon fiber bundles in one direction, as needed, cut and laminated prepreg, is cured with the thermosetting resin in an autoclave under a high-temperature and high-pressure condition, a CFRP excellent in mechanical properties or thermal stability can be easily obtained, and the method is broadly employed in uses requiring high performance such as aerospace fields. However, in that autoclave molding process, although a CFRP with high performances is easily obtained, there are problems in that the time required for molding is long and the shape of the CFRP is restricted. On the other hand, there is an RTM (Resin Transfer Molding) process as the other process for producing a CFRP. This is a process wherein a carbon fiber base material free from resin (for example, a base material such as a woven fabric) is placed in a mold, and thereafter, a resin is injected and cured. In that process, as compared to an autoclave molding process, because the shape fittability of the CFRP can be widened and, further, because the time required for molding can be shortened, it is expected to be widely applied in the future for use in automobiles, in particular, in uses for mass-produced automobiles.

In that RTM process, in the case where a CFRP having a 3D shape is produced, it is common to cut a carbon fiber base material in a predetermined pattern, to laminate and place it in a mold. Because the above-described carbon fiber base material is usually produced as a continuous sheet with a constant width, edge materials are inevitably generated at the above-described cutting before molding. Depending upon the cut pattern of the carbon fiber base material, there is a case where the edge materials are generated in an amount of 30 to 70% of the carbon fiber base material. Since the development of use of CFRP in the future is expected as described above, a technology is required to recycle these edge materials generated in the production process of CFRP.

Because carbon fibers are high in chemical and thermal stabilities, however, it is difficult to employ a chemical recycle that recycles the carbon fibers as a raw material by dissolution, melting, decomposition and the like. Since carbon fibers contained in an edge material of carbon fiber base material become discontinuous fibers by cutting continuous fibers, they have a broad distribution from very long to very short in fiber length and the carbon fibers are frequently restrained by a weave style, a textile structure or stitch yarns, and as the case may be, they are further welded more strongly by a binder or a tackifier (a form of particles or thermo-fusible yarns and the like), performance for recycling thereof is very poor. Thus, it is difficult to recycle them into a carbon fiber base material itself. Therefore, although a method is considered wherein an edge material of a carbon fiber base material is cut and then compounded with a thermoplastic resin and, thereafter, the mixture is injection molded to produce a CFRP, in the case where such an edge material is cut and injection molded as it is, because carbon fibers are not sufficiently distributed into the thermoplastic resin or because a CFRP short in fiber length is produced if the mixing condition at the time of injection molding is intensified to sufficiently distribute the carbon fibers into the thermoplastic resin, in both cases, only a CFRP with low mechanical properties can be obtained.

As a method of recycling fibers other than carbon fibers, a method is disclosed in JP-A-2005-105491 wherein discontinuous fibers obtained from a used product comprising high-functional fibers such as fully aromatic polyamide fibers and new high-functional fibers are mixed and therefrom recycled high-functional spun yarns are obtained. However, that method recycles a product using high-functional spun yarns again to high-functional spun yarns, and it cannot be employed to recycle a carbon fiber base material.

Further, in JP-A-2009-66885 and JP-A-06-288084, a recycling method is disclosed comprising a cutting waste crushing step that crushes cutting wastes containing chemical fiber woven fabric or knit fabric and a curing agent impregnation step to impregnate a thermo-reactive curing agent into the crushed cutting waste and wherein a molded material is formed by thermal-press molding of the cutting waste impregnated with the curing agent. However, that method recycles synthetic fibers such as polyester fibers, the mechanical properties of the molded product obtained are low, and it is not adaptable to recycle a carbon fiber base material.

Moreover, recycling a CFRP by injection molding is known. For example, JP-A-2006-218793 discloses a method wherein a carbon fiber-reinforced thermoplastic resin molded product is crushed to make pellets, and they are blended with virgin carbon fiber-reinforced thermoplastic resin pellets to be used in injection molding. However, that method is a method wherein a CFRP after injection molding is recycled by being injection molded with a matrix resin, and it is not adaptable to recycling of a carbon fiber base material that is before resin impregnation.

Except those, in JP-A-2009-138143, a recycling method is disclosed wherein a CFRP comprising carbon fibers and a thermosetting resin is heat treated to make a residue of carbon fibers by burning the thermosetting resin and, thereafter, the residue is compounded with a thermoplastic resin. However, in that method, even if such a residue of carbon fibers is compounded as it is, similarly to the above-described method of directly injection molding an edge material of a carbon fiber base material, the carbon fibers are left at a condition of not being satisfactorily distributed into the thermoplastic resin, or the fiber length of the carbon fibers becomes short and, therefore, a CFRP excellent in mechanical properties cannot be obtained.

Furthermore, it is attempted to make carbon fibers, which have been recovered by dissolving and removing an epoxy resin of a matrix resin from a CFRP, into a nonwoven fabric by carding (Hitachi Chemical Company, Ltd. homepage “Ministry of Economy, Trade and Industry, regional new industry creation technology development assistant enterprise “epoxy CFRP recycle by normal pressure dissolution method”” http://www.hitachi-chem.co.jp/Japanese/csr/files/frp_recycling_technology_{—}2.pdf). In that method, originating from the dissolution and removal of the matrix resin, the yield at the time of making the nonwoven fabric is low, and the mechanical properties of a CFRP obtained, the mass productivity of the nonwoven fabric and the cost of processing are not satisfactory. Concretely, mainly the following points are causes. First, when the matrix resin is removed from the carbon fiber-reinforced plastic, although it is necessary to dip it in a chemical or solvent or the like and pressurize and heat it, at that time, not only the matrix resin, but also a sizing agent on the surfaces of carbon fibers are lost. The sizing agent has a function of enhancing the adhesive property between the carbon fibers and the matrix resin even if a carbon fiber-reinforced plastic is made by using the above-described carbon fibers lost with the sizing agent, only low mechanical properties can be obtained. Further, the carbon fibers recovered by the above-described method are diverse in length, and very short carbon fibers and very long carbon fiber are included. The very short carbon fibers are not preferable, because such carbon fibers easily sink on a cylinder roll or a worker roll in a carding process and, as a result, winding the carbon fibers onto the roll or, to the contrary, falling off from the roll can occur. Further, the very long carbon fibers are liable to tangle and reside in a carding machine in a lump condition. The residing carbon fibers are cut as time passes and short carbon fibers are generated in a large amount. As a result, winding the carbon fibers to the roll or falling off from the roll occurs and such a state is not preferred. Further, in the above-described method, the recovered carbon fibers are in a fuzz ball tangled state and until such fuzz balls become smaller by cutting the recovered carbon fibers, it cannot pass through a clearance point between respective rolls of the carding machine. Therefore, the length of the recovered carbon fibers contained in a finally obtained carbon fiber-reinforced plastic becomes shorter and the mechanical properties become lower.

Namely, most of the recycle technologies of carbon fibers disclosed so far recycle CFRP again to CFRP, the mechanical properties of a CFRP obtained are not satisfactory, and there has been no technologies so far wherein an edge material of a carbon fiber base material generated in a process of producing a CFRP is recycled to a CFRP with high mechanical properties or a carbon fiber aggregate used for production of the CFRP, while an excellent mass productivity is ensured.

Accordingly, it could be helpful to provide a method of producing a carbon fiber aggregate and a method of producing a carbon fiber-reinforced plastic, to recycle an edge material of a carbon fiber base material generated in a CFRP production process into a CFRP having high mechanical properties.

### SUMMARY

We thus provide methods of producing a carbon fiber aggregate and for producing a carbon fiber-reinforced plastic. Namely, our method of producing a carbon fiber aggregate is characterized in that an edge material of a carbon fiber base material composed of carbon fibers is cut to obtain a cut piece, and the cut piece is made into a web and/or made into a nonwoven fabric to obtain a carbon fiber aggregate.

Further, our method of producing a carbon fiber-reinforced plastic is characterized in that a matrix resin is impregnated into a carbon fiber aggregate produced by the above-described method.

In the method of producing a carbon fiber aggregate, after the cut pieces are obtained by cutting the edge materials of a carbon fiber base material before impregnation of a matrix resin, the cut pieces are made into a web and/or a nonwoven fabric (preferably, carded and/or punched). In this carding step and/or punching step, the cut pieces are refined and the carbon fibers are oriented while shortening of the fiber length of the carbon fibers by breakage is suppressed and, even if a binder or a tackifier is applied to the carbon fiber base material, a carbon fiber aggregate such as a web or a nonwoven fabric capable of being recycled into carbon fiber-reinforced plastics (CFRP) having various forms can be easily obtained. In particular, if thermoplastic resin fibers or glass fibers are added to the above-described cut pieces at the steps of carding and/or punching, the mass productivity thereof can become higher, and the cost of production can be reduced more.

Further, in the above-described carbon fiber aggregate, because carbon fibers having a predetermined length are refined, the variation in areal weight of carbon fibers (CV value) is small, the critical shear deformation angle thereof is large, and the shape fittability into a complicated shape is excellent.

In the CFRP obtained by impregnating a matrix resin into the carbon fiber aggregate prepared by the above-described method, because carbon fibers having a predetermined length are refined, the moldability is good, and the mechanical properties are excellent. Such a carbon fiber aggregate can be impregnated with a matrix resin and molded by a resin transfer molding (RTM), a vacuum assisted resin transfer molding (VaRTM) or a reaction injection molding (RIM). Further, an injection molding or a press molding can also be employed after impregnation of the matrix resin, and the matrix resin can also be impregnated by press molding.

### BRIEF DESCRIPTION OF THE DRAWINGS

FIG. 1 is a schematic diagram showing an example of a carding step to make cut pieces of an edge material of a carbon fiber base material.

FIG. 2 is a block diagram showing an example of a process flow of a method of producing a carbon fiber aggregate and a method of producing a carbon fiber-reinforced plastic.

### EXPLANATION OF SYMBOLS

1: carding machine
2: cylinder roll
3: take-in roll
4: doffer roll
5: worker roll
6: stripper roll
7: feed roll
8: belt conveyer
9: cut piece
10: web

### DETAILED DESCRIPTION

Hereinafter, our methods will be explained in detail together with examples.

In our method of producing a carbon fiber aggregate, an edge material of a carbon fiber base material (such as a woven fabric, a multiaxial stitch fabric or a braid described later) composed of carbon fibers is cut to obtain a cut piece and such a cut piece is made into a web and/or made into a nonwoven fabric (preferably, by carding, punching or the like described later) to obtain a carbon fiber aggregate.

As the carbon fibers, although not particularly limited, PAN-base carbon fibers, pitch-base carbon fibers, cellulose-base carbon fibers, vapor grown-base carbon fibers and graphitized fibers thereof can be used. PAN-base carbon fibers are carbon fibers the raw material of which is polyacrylonitrile fibers. Further, pitch-base carbon fibers are carbon fibers the raw material of which is petroleum tar or petroleum pitch. Further, cellulose-base carbon fibers are carbon fibers the raw material of which is viscose rayon, cellulose acetate and the like. Furthermore, vapor grown-base carbon fibers are carbon fibers the raw material of which is hydrocarbon and the like. Among these, from the viewpoint of excellent balance between strength and elastic modulus, PAN-base carbon fibers are preferable. Furthermore, metal coated carbon fibers, prepared by coating the above-described carbon fibers with a metal such as nickel or copper, can be used. The density of carbon fibers is preferably 1.65 to 1.95 g/cm³, and more preferably 1.70 to 1.85 g/cm³. If the density is too high, the lightness in weight of a carbon fiber-reinforced plastic obtained is poor and, if too low, the mechanical properties of a carbon fiber-reinforced plastic obtained may become low. Further, the size (diameter) of carbon fibers is preferably 5 to 8 μm per one fiber, and more preferably 6.5 to 7.5 μm. If the diameter is too small, there is a tendency that the amount of dust generated at a process of making a web and/or a process of making a nonwoven fabric (preferably, a carding process and/or a punching process) increases or falling off from the process is liable to occur and, if too large, because of poor mechanical properties, a satisfactory reinforcement effect cannot be obtained. Further, for the purpose of improving the adhesive properties between carbon fibers and a matrix resin and the like, the carbon fibers can be surface treated. As the method of the surface treatment, there are electrolytic treatment, ozone treatment, ultraviolet treatment and the like. Further, for the purpose of preventing fuzz generation of carbon fibers, improving the adhesive property between carbon fibers and a matrix resin and the like, a sizing agent can be provided to the carbon fibers. A urethane compound, an epoxy compound and the like can be applied as the sizing agent.

The carbon fiber base material composed of carbon fibers indicated here comprises carbon fibers solely, or as needed, a combination with other inorganic fibers such as glass fibers or organic fibers. As its form, can be exemplified a uni-directional woven fabric in which fibers are arranged almost in a same direction and they are fixed with auxiliary yarns or binders, a bi-directional woven fabric in which at least carbon fibers are crossed in two directions, a multiaxial woven fabric in which they are crossed in multi directions, a multiaxial stitch fabric wherein sheets each prepared by arranging carbon fibers in one direction are laminated in multi directions and the laminate is bonded with stitch yarns, and other than those, a braid, a nonwoven fabric or a mat using discontinuous fibers and the like.

As the uni-directional woven fabric, for example, exemplified are a fabric wherein carbon fiber bundles are arranged in one direction in parallel to each other as warps and the warps and auxiliary wefts comprising, for example, glass fibers or organic fibers extending in one direction perpendicular to the warps are crossed to be woven, and a fabric having a so-called “non-crimp” structure which comprises warps comprising carbon fiber bundles, auxiliary warps of small yield fiber bundles comprising glass fibers or organic fibers arranged in parallel to the warps, and auxiliary wefts of small yield fiber bundles comprising glass fibers or organic fibers arranged perpendicularly to the warps and the auxiliary warps, and wherein the carbon fiber bundles are integrally held almost without being crimped to form a woven fabric, by a structure where the auxiliary warps and the auxiliary wefts are crossed to each other.

Further, not being limited to a uni-directional woven fabric, a bi-directional woven fabric using carbon fibers as warps and/or wefts can also be used. Such a bi-directional woven fabric is not particularly limited, and a plain weave fabric, a twill weave fabric, a satin weave fabric, a jacquard weave fabric and the like can be used. As the woven fabric, a multiaxial woven fabric can be used. The multiaxial woven fabric is a woven fabric which is woven by using yarns provided from three or more directions to weave a bamboo basket, and typically, a three-axes woven fabric woven with yarns provided from three directions each shifted by 60 degrees in angle, a four-axes woven fabric woven with yarns provided from four directions each shifted by 45 degrees in angle and the like can be exemplified.

Further, as the base material, a multiaxial stitch fabric can be used. The multiaxial stitch fabric indicated here means a base material wherein reinforcing fiber bundles are arranged in one direction to make a sheet, a plurality of the sheets are laminated while changing the angles of the sheets, and a base material, prepared by stitching the laminate with a stitch yarn such as a NYLON yarn, a polyester yarn or a glass fiber yarn to penetrate through the laminate in its thickness direction and to go back and forth between the surface and the back surface of the laminate and along the surface direction, is bonded by a stitch yarn. Except those, a braid prepared by arranging carbon fibers in a specified direction and interlacing them, a nonwoven fabric or a mat prepared by arranging discontinuous carbon fibers two-dimensionally or three-dimensionally and integrating them with auxiliary yarns or binders and the like can be used.

The carbon fiber bundles forming a carbon fiber base material (such as the woven fabric) are disentangled and refined by the step of making a web described later. Therefore, the number of single fibers of carbon fibers in the carbon fiber bundles forming a carbon fiber base material does not greatly directly affect the performance of a carbon fiber-reinforced plastic finally obtained. Accordingly, although the number of carbon fibers contained in the carbon fiber bundles forming the woven fabric is not particularly restricted, as long as they are carbon fiber bundles each comprising single fibers of carbon fibers in a range of 1,000 to 60,000 in number of fibers which is generally used to make the carbon fiber woven fabric, they can be used without problems.

In the carbon fiber base material, fibers other than carbon fibers can be contained. Concretely, inorganic fibers such as glass fibers, metal fibers and ceramic fibers, and organic fibers such as polyamide fibers, polyester fibers and phenolic resin fibers, can be contained. As examples containing such inorganic fibers, wefts of a uni-directional woven fabric or a non-crimp woven fabric, auxiliary yarns for forming a resin flow path at the time of resin impregnation and the like can be raised. Further, as examples containing such organic fibers, yarns for welding to prevent a broken alignment pattern of carbon fibers or stitch yarns for a multiaxial stitch fabric can be raised. However, if the content of these fibers other than carbon fibers is too much, because there is a case where the properties of a carbon fiber-reinforced plastic may be knocked down, or a case where the uses capable of being used are restricted, the content thereof in a carbon fiber base material is preferably not more than 10 wt. %, more preferably not more than 5 wt. %.

Further, for the carbon fiber base material to be used, a binder, a tackifier, particles for reinforcing interlayer and the like can be applied at a discontinuous or particle shape. If a binder or a tackifier is applied for the carbon fiber base material, because the carbon fiber base material is fixed or stabilized in a form more strongly, generally it becomes difficult to make it into a web. However, even if such a carbon fiber base material is used, by passing through a preferred step wherein after cut pieces of an edge material of a carbon fiber base material (for example, cut pieces having a predetermined length or less in carbon fiber length) are obtained, preferably the cut pieces are refined by passing through a refining step described later, and the refined cut pieces are made into a web, desired effects can be exhibited. Namely, in the case where a binder or the like is applied, even in a case where it is desired that carbon fibers in a carbon fiber aggregate being obtained are almost uniformly refined nearly to a single fiber level, by passing through a refining step described later wherein adequate-form cut pieces of a carbon fiber base material are refined, for example, it becomes possible to obtain a carbon fiber aggregate excellent in uniformity in which the coefficient of variation (CV value) in areal weight or thickness of carbon fibers is less than 10%. Therefore, to use a carbon fiber base material applied with such a binder or tackifier at a particle condition, and further to pass through the refining step described later, is preferred to achieve the desired effect as much as possible.

On the other hand, in the case where a form is desired wherein carbon fibers in a carbon fiber aggregate are not uniformly refined nearly to a single fiber level and a form of a carbon fiber bundle is partially left, to the contrary, if a carbon fiber base material applied with a binder or a tackifier is used, because the carbon fiber bundle is fixed or stabilized in a form more strongly than that in a usual carbon fiber base material, the form of the carbon fiber bundle can easily be partially left.

Further, as the above-described particles, particles can be exemplified which are comprised solely of a resin or using a compound of resins such as a polyamide, a polyolefin, a polyester (including an unsaturated polyester), a polyvinyl formide, a polyether sulfone, a polyphenylene sulfide, a vinyl acetate, a vinyl ester, an epoxy, and a phenol. Although the content of such particles is not particularly restricted, because, depending upon the combination of a resin forming the particles and a matrix resin for making the carbon fiber-reinforced plastic, there is a case where the properties of a carbon fiber-reinforced plastic finally obtained may be lowered or where the uses thereof capable of being used are limited, the content in the carbon fiber base material is preferably 25 wt. % or less, more preferably 10 wt. % or less, and further preferably 5 wt. % or less.

The method of producing a carbon fiber aggregate includes a step of obtaining a cut piece by cutting an edge material of a carbon fiber base material composed of carbon fibers, and a step of obtaining a carbon fiber aggregate by making such a cut piece into a web and/or made into a nonwoven fabric. The method of producing a carbon fiber-reinforced plastic further includes a step of impregnating a matrix resin into such a carbon fiber aggregate. Although various means such as carding, air laid, paper making, or punching can be applied for making the web and/or nonwoven fabric, carding and/or punching is preferred. To tangle fibers to each other more securely, application of both steps of the carding step and the punching step is more preferred.

By cutting an edge material of a carbon fiber base material to obtain a cut piece, in the step of making a web described later, for example, in the case of using carding, controlling the feeding amount of carbon fibers to be fed into the machine can be facilitated, and the quality of a carbon fiber aggregate to be obtained can be stabilized. Further, it is important in such a cutting to control the length of carbon fibers at a predetermined length or less. If carbon fibers which are too long in fiber length are contained, because the carbon fibers may be wound onto a roll in the carding machine in the carding step or the moldability may be spoiled when a carbon fiber-reinforced plastic is molded, and such a condition is not preferred. We found that by cutting a carbon fiber base material composed of carbon fibers in advance controls the length of the carbon fibers at a predetermined length or less. The method of cutting carbon fibers is thus not particularly restricted, wherein a method such as a rotary cutter or a Guillotine cutter, punching by a Thomson cutter mold, a ultrasonic cutter can be applied. In particular, as a method of obtaining the cut piece at a high productivity, punching by a Thomson cutter mold is preferred.

Further, it is preferred to perform the step of refining the cut piece in advance, prior to making a web. In particular, in the case where a binder or a tackifier is applied to a carbon fiber base material as aforementioned, by refining the cut piece in advance, making a web or a nonwoven fabric is facilitated. Further, by performing the refining step in advance, in the carding step or the punching step described later, it can be performed more easily to arrange the direction of the fibers or to refine the fibers. Means for refining the cut piece in advance is not particularly restricted, and a refining machine or an opening machine using a cutter, a large nail, a saw blade, various kinds of wires and the like such as a flat carding machine or a roller carding machine can be used. In particular, in the case where a binder or a tackifier is applied to a carbon fiber base material, because carbon fiber bundles are fixed or stabilized in a form more strongly than those in a usual carbon fiber base material, it is further preferred to pass the base material through the refining machine several times to refine it sufficiently.

Carding means an operation of arranging the direction of discontinuous fibers or refining fibers by applying a force in approximately the same direction to an aggregate of discontinuous fibers with a comb-like member. Generally, it is performed using a carding machine equipped with a roll having many needle-like projections on the surface and/or a roll wound with a metallic wire having saw blade-like projections.

When such a carding is carried out, it is preferred to control the time (residing time), during which carbon fibers reside in the carding machine, to be short, to prevent the carbon fibers from being folded. Concretely, it is preferred to transfer the carbon fibers existing on the wires wound onto a cylinder roll of the carding machine (the structure of the machine will be exemplified later) to a doffer roll in a time as short as possible. Therefore, to accelerate such a transfer, it is preferred to rotate the cylinder roll at a high rotational speed, for example, such as 300 rpm or higher. Further, for a similar reason, the surface speed of the doffer roll is preferably a high speed, for example, such as 10 m/min. or higher. Further, similarly, it is important to widen the clearance between respective rolls as compared to that in the carding of usual organic fibers to prevent carbon fibers from sinking on the surfaces of the cylinder roll, worker rolls, stripper rolls or the like by being pressed thereto. For example, the respective clearances between rolls of the cylinder roll, worker rolls and stripper rolls are set preferably at 0.5 mm or more, more preferably 0.7 mm or more, and further preferably 0.9 mm or more.

Further, the carbon fiber aggregate means an aggregate kept in a form by tangle or friction of fibers to each other at a condition where discontinuous fibers are refined and oriented by the above-described carding, and exemplified are a thin sheet-like web, a rope-like sliver obtained by twisting and/or stretching a web, a nonwoven fabric obtained by laminating webs, as needed, by tangle or adhesion or the like.

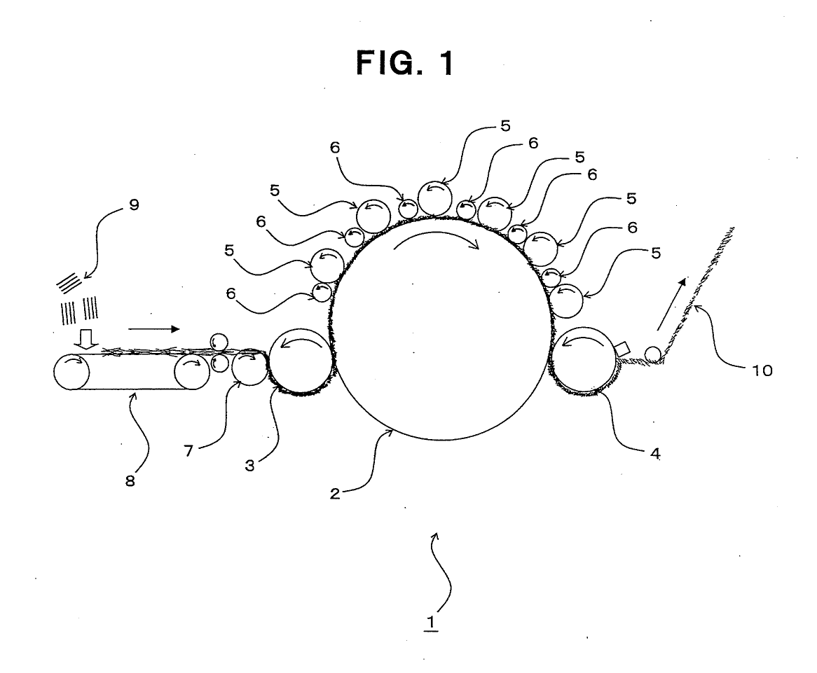

FIG. 1 is a schematic diagram showing an example of a carding step of making cut pieces of an edge material from a carbon fiber base material. A carding machine 1 shown in FIG. 1 mainly comprises a cylinder roll 2, a take-in roll 3 provided closely to the outer circumferential surface of the cylinder roll 2, a doffer roll 4 provided closely to the outer circumferential surface of the cylinder roll 2 at a side opposite to the side of the take-in roll 3, a plurality of worker rolls 5 provided closely to the outer circumferential surface of the cylinder roll 2 between the take-in roll 3 and the doffer roll 4, stripper rolls 6 provided closely to the worker rolls 5, and a feed roll 7 provided closely to the take-in roll 3 and a belt conveyer 8.

Cut pieces 9 of an edge material of a carbon fiber base material are supplied to belt conveyer 8, and the cut pieces 9 are provided onto the outer circumferential surface of cylinder roll 2 through the outer circumferential surface of feed roll 7 and then through the outer circumferential surface of take-in roll 3. Up to this stage, cut pieces 9 are disentangled and become cotton-like carbon fibers at a condition where the form of the edge material of the carbon fiber base material is not kept. Although a part of the cotton-like carbon fibers provided onto the outer circumferential surface of cylinder roll 2 wind around the outer circumferential surface of worker rolls 5, these carbon fibers are stripped off by stripper rolls 6 and returned again onto the outer circumferential surface of the cylinder roll 2. Many needles, projections exist at standing conditions on the outer circumferential surfaces of the respective rolls of feed roll 7, take-in roll 3, cylinder roll 2, worker rolls 5 and stripper rolls 6, and in the above-described steps, by the operation of the needles, carbon fibers are refined into a single-fiber condition and at the same time the directions thereof are arranged. The carbon fibers, refined and promoted in fiber orientation through such steps, move onto the outer circumferential surface of doffer roll 4 as a sheet-like web 10 which is one form of a carbon fiber aggregate. Further, by drawing the web 10 while narrowing the width thereof, a fibrous sliver, which is another form of a carbon fiber aggregate, can be obtained.

Although the carbon fiber aggregate can be formed by only carbon fibers, thermoplastic resin fibers or glass fibers can also be contained. In particular, it is preferred to add thermoplastic resin fibers or glass fibers when cut pieces are carded because not only breakage of carbon fibers at the carding can be prevented, but also the amount of the output can be increased. Because carbon fibers are rigid and fragile, they are hard to be tangled and liable to be broken. Therefore, there is a problem in the carbon fiber aggregate formed by only carbon fibers that during production, it is easily cut or carbon fibers are liable to fall off. Accordingly, by containing thermoplastic resin fibers or glass fibers which are relatively flexible and hard to be broken and liable to be tangled, a carbon fiber aggregate high in uniformity can be formed. In the case where thermoplastic resin fibers or glass fibers are contained in a carbon fiber aggregate, the content of carbon fibers in the carbon fiber aggregate is preferably 20 to 95 mass %, more preferably 50 to 95 mass %, and further preferably 70 to 95 mass %. If the content of carbon fibers is low, it becomes difficult to obtain high mechanical properties when a carbon fiber-reinforced plastic is made and, to the contrary, if the content of thermoplastic resin fibers or glass fibers is too low, an advantage in improving the above-described uniformity of the carbon fiber aggregate cannot be obtained.

In the case where thermoplastic resin fibers or glass fibers are contained in a carbon fiber aggregate, the fiber length of the contained fibers is not particularly limited as long as it is in a range capable of achieving the desired effect such as keeping the form of the carbon fiber aggregate or preventing falling off of carbon fibers and, generally, thermoplastic resin fibers or glass fibers having a length of approximately 10 to 100 mm can be used. It is also possible to decide the fiber length of thermoplastic resin fibers relatively in accordance with the fiber length of carbon fibers. For example, when a carbon fiber aggregate is stretched, because a stronger tension is applied to a fiber longer in fiber length, in the case where it is desired to orient carbon fibers in the lengthwise direction of the carbon fiber aggregate by applying a tension to the carbon fibers, the fiber length of the carbon fibers can be set longer than the fiber length of thermoplastic resin fibers or glass fibers and, in a contrary case, the fiber length of the carbon fibers can be set shorter than the fiber length of thermoplastic resin fibers or glass fibers.

Further, it is preferred to provide a crimp to the above-described thermoplastic resin fibers to enhance the effect of tangling due to the thermoplastic resin fibers. The degree of the crimp is not particularly limited as long as it is in a range capable of achieving the desired effect and, generally, thermoplastic resin fibers having a number of crimps of approximately 5 to 25 crests per 25 mm and a rate of crimp of approximately 3 to 30% can be used.

The material for such thermoplastic resin fibers is not particularly restricted, and it can be appropriately selected from a range that does not greatly reduce the mechanical properties of a carbon fiber-reinforced plastic. Concretely, fibers can be used which are prepared by spinning a resin such as a polyolefin-group resin such as polyethylene or polypropylene, a polyamide-group resin such as NYLON 6 or NYLON 6,6, a polyester-group resin such as polyethylene terephthalate or polybutylene terephthalate, a polyetherketone, a polyketone, a polyetheretherketone, a polyphenylene sulfide, an aromatic polyamide or a phenoxy. It is preferred that such a material for thermoplastic resin fibers is appropriately selected in accordance with the combination with a matrix resin to be impregnated into a carbon fiber aggregate. Further, it is preferred to especially employ fibers using a recycled thermoplastic resin as the thermoplastic resin fibers, from the viewpoint of improvement of recycling properties.

As the thermoplastic resin fibers, in particular, thermoplastic resin fibers prepared using the same resin as a matrix resin, a resin having a compatibility with a matrix resin or a resin having a high adhesive property with a matrix resin are preferred, because the mechanical properties of a carbon fiber-reinforced plastic are not lowered. For example, the thermoplastic resin fibers are preferred to be composed of at least one kind of fibers selected from the group consisting of polyamide fibers, polyester fibers, polyphenylene sulfide fibers, polypropylene fibers, polyetheretherketone fibers and phenoxy resin fibers.

When a matrix resin is impregnated into a carbon fiber aggregate, a method may be employed wherein a carbon fiber aggregate containing thermoplastic resin fibers is prepared and the thermoplastic resin fibers contained in the carbon fiber aggregate are used as the matrix resin as they are, or a method can also be employed wherein a carbon fiber aggregate not containing thermoplastic resin fibers is used as a raw material, and a matrix resin is impregnated at an arbitrary stage of producing a carbon fiber-reinforced plastic. Further, even in the case where a carbon fiber aggregate containing thermoplastic resin fibers is used as a raw material, a matrix resin can be impregnated at an arbitrary stage of producing a carbon fiber-reinforced plastic. In such a case, a resin forming thermoplastic resin fibers and a matrix resin can be an identical resin, and can be resins different from each other. In the case where the resin forming thermoplastic resin fibers and the matrix resin are different from each other, both resins can be thermoplastic resins, and can also be a combination of a thermoplastic resin and a thermosetting resin. However, in the case where the resin forming thermoplastic resin fibers and the matrix resin are different from each other, it is preferred that both resins have a compatibility or a high affinity, for example, the solubility parameters (SP value) defined in the following Equation 1 are preferably close to each other, because the mechanical properties of FRP become high:

δ=√(ΔE/V) (1)

where ΔE is an evaporating energy, and V is a molar volume.

On the other hand, in the case where thermoplastic resin fibers are used, for example, where a reduction of the carbon fiber-reinforced plastic properties is observed at an environmental test (an environmental test such as a heat cycle between a high temperature and a low temperature) or a reduction of mechanical properties after the environmental test, it is preferred to use glass fibers which are inorganic fibers, instead of a part of or the whole of the thermoplastic resin fibers. As the glass fibers, although various glass fibers such as E-glass, S-glass or T-glass fibers can be used, in particular, it is preferred to employ recycled glass fibers, from the viewpoint of improvement of recycling properties.

As the form of the carbon fiber aggregate obtained by the above-described method, a web or a nonwoven fabric is preferred from the viewpoint of the suitability for wide use and mass production, and the cost of production. Except those, it can be processed into a desired form. For example, spun yarns can be made by stretching and twisting a sliver, which is one form of a carbon fiber aggregate, using a spinning frame or the like. For example, spun yarns can be obtained by passing through a drawing step of orienting the fibers while reducing unevenness of the thicknesses of slivers by gathering a plurality of slivers and stretching them, a roving step of making so-called “rovings” by orienting the fibers by twisting the slivers while stretching them to increase the strength of the spun yarns, and a fine spinning step of twisting the spun yarns while further stretching the spun yarns to increase the strength as well as making spun yarns with a predetermined thickness. In such a processing, for example, in the fine spinning step, a machine such as a ring spinning frame, a compact spinning frame or an open-end spinning frame can be used. The spun yarns thus prepared, containing discontinuous inorganic fibers, can be made into a CFRP, for example, after being made into a woven fabric. As the woven fabric, a general woven fabric such as a plain weave fabric, a twill weave fabric or a satin weave fabric, a three-dimensional woven fabric, a multiaxial stitch fabric, a uni-directional woven fabric or the like can be employed.

The variation in areal weight or variation in thickness of carbon fibers (CV value) in a carbon fiber aggregate is preferably less than 10%. If the CV value is 10% or more, the weight or thickness of a CFRP varies locally, and the appearance and the like may be damaged. Further, if the CV value is 10% or more, when a carbon fiber composite is made, in the case where a matrix resin impregnated by infusion moldings, concretely, by resin transfer molding (RTM), vacuum assisted resin transfer molding (VaRTM) or reaction injection molding (RIM), there is a case where the matrix resin locally flows preferentially through a portion small in areal weight (or thickness) and a uniform impregnation cannot be achieved. As a result, the matrix resin cannot be spread over the entire surface or voids are generated in a CFRP and the mechanical properties are remarkably damaged. Such a condition is not preferred. A carbon fiber aggregate having a variation in areal weight or a variation in thickness in the above-described range can be easily obtained by passing through a cutting step of cutting an edge material of a carbon fiber base material, a refining step of refining the cut piece and a carding and/or punching step of making the refined cut piece into a web or a nonwoven fabric.

It is preferred that the critical shear deformation angle of a carbon fiber aggregate is 30 degrees or more. This critical shear deformation angle is one of indexes of shape traceability into a complicated shape, and it is determined as follows. A carbon fiber aggregate having a critical shear deformation angle in the above-described range can be easily obtained, similarly, by passing through the above-described cutting step, refining step, and carding and/or punching step.

A jig is prepared wherein frames are disposed to form a rectangle or a lozenge and each vertex is fixed by a pin and which is movable in a diagonal direction, and a carbon fiber base material is cut out as a rectangular test piece along the size of the jig. The cut-out test piece is set so that sides of the test piece and the sides of the jig become parallel to each other. (Refer to FIG. 4 of JP-A-2007-162185 as to the outline of the jig and the attachment condition of the test piece. The frames can clamp the test piece.). By deforming the frames into a lozenge by applying a tensile load thereto, shear load is transmitted to the test piece of the carbon fiber base material. While applying a shear load until wrinkles are generated in the plane of this test piece at a portion apart from the clamp part or a free end part at least by 1 cm or more, a curve in relation to a loaded tensile load and a change in angle when the jig is deformed to a lozenge is obtained. In this curve, a point at which a great inflection point is generated, or an angle at which the above-described wrinkles are generated, is defined as a critical shear deformation angle. If the critical shear deformation angle of a carbon fiber aggregate is less than 30 degrees, in the case of being formed into a complicated form, the carbon fiber aggregate can generate wrinkles, unevenness is formed on a surface of a CFRP or a CFRP having a predetermined shape cannot be obtained. Such a condition is not preferred.

As a matrix resin used for production of a CFRP, a thermosetting resin is preferred from the viewpoint of the moldability and the mechanical properties. As the thermosetting resin, at least one resin selected from an epoxy, a phenol, a vinyl ester, an unsaturated polyester, cyanate ester and a bismaleimide is preferably used. Further, a resin added with an elastomer, a rubber, a curing agent, a curing accelerator, a catalyst and the like can also be used. Among those, to achieve very high mechanical properties required for a structural member of a transportation device such as an airplane or an automobile, an epoxy resin and, to achieve a high thermal resistance, a bismaleimide resin, are preferred, and in particular, an epoxy resin is preferably used.

As the matrix resin, thermoplastic resins can also be used, for example, such as a polyolefin, an ABS, a polyamide, a polyester, a polyphenylene ether, a polyacetal, a polycarbonate, a polyphenylene sulfide, a polyimide, a polyetherimide, a polyether sulfone, a polyketone, a polyetheretherketone, a polyetherketoneketone, and a combination thereof. Further, a thermoplastic resin precursor such as a polyamide for RIM, a cyclic polybutylene terephthalate and a polycarbonate can also be used.

When a matrix resin is impregnated into a carbon fiber aggregate as described above, the matrix resin can be impregnated after the carbon fiber aggregate is processed into a woven fabric and the like, and the matrix resin can be impregnated directly into the carbon fiber aggregate produced by carding.

In the case where the resin is impregnated after a woven fabric is made from a carbon fiber aggregate, a method can be employed wherein a matrix resin is impregnated into a woven fabric made from spun yarns exemplified above by a known method. For example, a carbon fiber-reinforced plastic can be made by a molding method wherein a prepreg or a semipreg is prepared by impregnating a matrix resin, and thereafter it is heated and cured while being pressurized in an autoclave.

Further, as a more preferable molding method, infusion molding methods can be exemplified such as a resin transfer molding (RTM), resin film infusion (RFI), reaction injection molding (RIM) or vacuum assisted resin transfer molding (VaRTM), which is high in productivity. Among those, from the viewpoint of cost for molding, an RTM and a vacuum assisted resin transfer molding are preferably employed. As the RTM, for example, there is a molding method of injecting a pressurized resin into a cavity formed by a male mold and a female mold, and preferably, the resin is injected after the cavity is reduced in pressure. Further, as the vacuum assisted resin transfer molding, for example, there is a molding method of reducing in pressure a cavity formed by one of a male mold and a female mold, and a bag material such as a film (for example, a bag material such as a NYLON film or a silicone rubber), and infusing a resin by a pressure difference with an atmospheric pressure and, preferably, a resin distribution medium is placed on a preform in the cavity to accelerate the resin impregnation, and after the molding, the medium is separated from the composite material. In the case where the above-described method is employed, the matrix resin is preferably a thermosetting resin or a thermoplastic resin precursor.

Further, in such an infusion molding, it is preferred to impregnate a matrix resin into a laminate as the preform prepared by laminating a carbon fiber aggregate and a carbon fiber base material different from the carbon fiber aggregate in an approximate sandwich form so that the carbon fiber aggregate becomes a core of the sandwich. As a simplest concrete example, raised is a lamination structure of “a carbon fiber base material different from a carbon fiber aggregate/a carbon fiber aggregate/a carbon fiber base material different from a carbon fiber aggregate.” If the preform is formed at a lamination structure of such an approximate sandwich form, the carbon fiber base material excellent in mechanical properties functions as a skin layer, and the mechanical properties as a carbon fiber-reinforced plastic can be exhibited more highly. Further, also as its appearance, a design property of the carbon fiber base material can be expressed and, therefore, it is preferred. Of course, a lamination structure such as “a carbon fiber base material different from a carbon fiber aggregate/a carbon fiber aggregate/a carbon fiber aggregate/a carbon fiber base material different from a carbon fiber aggregate” or “a carbon fiber base material different from a carbon fiber aggregate/a carbon fiber aggregate/a carbon fiber base material different from a carbon fiber aggregate/a carbon fiber aggregate/a carbon fiber base material different from a carbon fiber aggregate” is included in the above-described lamination structure of an approximate sandwich form. It is not always necessary that the outermost surface of a preform is formed by a carbon fiber base material different from a carbon fiber aggregate and, depending upon the use, a glass fiber mat or a carbon fiber mat, or a carbon fiber aggregate may be disposed.

Further, the number average fiber length of carbon fibers contained in the carbon fiber aggregate is preferably 5 to 100 mm, more preferably 10 to 90 mm, and further preferably 20 to 70 mm. In the case where the number average fiber length of carbon fibers is shorter than 5 mm, it is not preferred because the mechanical properties of a carbon fiber-reinforced plastic obtained by impregnating a matrix resin into the carbon fiber aggregate become low. To the contrary, if the number average fiber length of carbon fibers exceeds 100 mm, because the carbon fibers are hard to move when a carbon fiber-reinforced plastic is molded, a range of shape capable of being molded becomes narrow. Such a condition is not preferred.

Further, the number average fiber length of carbon fibers contained in the cut piece is preferably 25 to 100 mm, more preferably 40 to 80 mm. By controlling the number average fiber length of carbon fibers in the cut piece in such a range, it becomes possible to control the number average fiber length of carbon fibers contained in a carbon fiber aggregate prepared by carding at 5 to 100 mm, preferably 10 to 90 mm, and more preferably 20 to 70 mm. Further, If the number average fiber length of carbon fibers in the cut piece is shorter than 25 mm, the carbon fibers are liable to sink on a cylinder roll or worker rolls at a carding step, and as a result, winding of the carbon fibers onto the roll or to the contrary, falling off thereof from the roll, is liable to occur. Such a condition is not preferred. Further, if the number average fiber length of carbon fibers in the cut carbon fiber base material is longer than 100 mm, the carbon fibers are liable to be tangled and liable to become a lump and stay in a carding machine. The stayed carbon fibers are cut as time passes and a lot of carbon fibers having a short fiber length are generated. As a result, winding of the carbon fibers onto a roll or to the contrary, falling off thereof from the roll, occurs, and such a state is not preferred.

Further, in the case where a carbon fiber bundle is cut to obtain cut pieces, it is preferred that the carbon fiber bundle before cutting is being spread. By the condition of being spread with the carbon fiber bundle, because it is liable to be caught by projections on the surfaces of a cylinder roll and worker rolls, it becomes hard to sink on the surfaces of those rolls and, as a result, winding of carbon fibers onto a roll or to the contrary, falling off thereof from the roll, hardly occurs. Such a state is preferred.

The above-described state where the carbon fiber bundle is being spread before being cut can be realized, for example, by using a carbon fiber base material using spread carbon fibers, in particular, by using a carbon fiber woven fabric after cutting. As such a woven fabric using spread carbon fibers, it is not particularly restricted as long as carbon fibers are spread, can be used a unidirectional woven fabric, a multiaxial woven fabric, a multiaxial stitch fabric, etc. As such woven fabrics, although woven fabrics described in JP-A-2003-268669, JP-A-2001-164441, JP-A-8-337960 and the like can be exemplified, except those, can be used woven fabrics applied with a usually known carbon fiber spreading method, namely, such as a method of squeezing a fiber bundle by a round bar, a method of spreading respective fibers by applying water flow or high-pressure air flow, a method of spreading respective fibers by vibrating the fibers by ultrasonic waves, or an air spreading method.

Further, when a carbon fiber-reinforced plastic is prepared by impregnating a matrix resin into a carbon fiber aggregate, without making the carbon fiber aggregate into a woven fabric, a carbon fiber-reinforced plastic can be prepared directly by the following exemplified method.

For example, a sliver, which is one form of a carbon fiber aggregate, can be injection molded by using an injection molding machine. In this case, a matrix resin is impregnated into a sliver in the injection molding machine, then, injected into a mold, and further, by consolidating the matrix resin, a carbon fiber-reinforced plastic can be obtained. As the injection molding machine, a machine such as an in-line screw type or a screw pre-plasticating type can be used. Further, it can also be done to add resin pellets, a stabilizer, a flame retarder, a colorant or the like to a sliver and supply it to the injection molding machine to make molded products. When the sliver is fed into an injection molding machine, it can also be performed to feed the sliver, after increasing the apparent density of the sliver or extinguishing hitching due to fuzz and thereafter twisting or stretching the sliver.

In the case where a carbon fiber-reinforced plastic is produced by injection molding as described above, it is preferred that the number average fiber length of carbon fibers contained in the carbon fiber-reinforced plastic obtained by the injection molding is 0.2 mm or more. In the case where the number average fiber length of carbon fibers is shorter than 0.2 mm, because the mechanical properties of the carbon fiber-reinforced plastic obtained become lower. Such a condition is not preferred. To the contrary, in the case where the above-described number average fiber length of carbon fibers exceeds 25 mm, flowability of the resin easily deteriorates, and a molded product having a desired shape may not be obtained or the flatness of the surface of the molded product may be spoiled. Such a condition is not preferred.

Further, in the case of a web or a nonwoven fabric which is one form of the carbon fiber aggregate, for example, a carbon fiber-reinforced plastic can be obtained by impregnating a matrix resin in advance as in a prepreg and thereafter press molding it. Except the above case, a carbon fiber-reinforced plastic can also be obtained, not by impregnating a matrix resin in advance, but by making a matrix resin into a form of a film or the like, laminating it with a web or a nonwoven fabric which is a carbon fiber aggregate, and impregnating the matrix resin by press molding. Because the process for impregnating a matrix resin by press molding is less in the number of steps, it is considered to be more advantageous from the viewpoint of cost. Although generally there is a case where a distinction between a web and a nonwoven fabric is not clear, a sheet, obtained by our carding step in a condition where carbon fibers are refined and oriented, but a processing of tangles, adhesions and the like of fibers to each other described later is not performed, is called as a web, and a sheet performed with the processing of tangles, adhesions and the like of fibers to each other is called as a nonwoven fabric.

Such a web is not particularly restricted and it is preferably a web obtained by carding cut pieces. Although a web generally has a relatively low areal weight in a range of ten-odd to several tens g/m² at a condition where it has come out from a carding machine as it is, it can be impregnated with a matrix resin as it is, and a matrix resin can also be impregnated with a matrix resin after the web is laminated until a desired areal weight is achieved, as the case may be, after it is entangled by passing through a punching step. To laminate the web, a known method can be employed, the web cut at a predetermined size in a sheet-form can be laminated, and the web can also be continuously laminated using an apparatus such as a cross-wrapper. Further, by performing a processing for tangling or adhering fibers forming such a web to each other, a nonwoven fabric improved with the stability in form can be obtained. By making such a nonwoven fabric, because the occurrence of elongation and wrinkles at a production process can be reduced, variation in properties of a carbon fiber-reinforced plastic can be reduced.

As a method for tangling carbon fibers to each other, a needle punching method, a fluid tangling method using a fluid such as air or water or the like can be used. Further, as a method for making carbon fibers adhere to each other, adhesion using a binder can be raised, and as the binder, a polyamide, a polyolefin, a polyester, a PVA, an acryl, a vinyl acetate, a polyurethane, an epoxy, an unsaturated polyester, a vinyl ester, a phenol and the like can be exemplified. By carding after such a binder is made into fibers or powder and mixed with carbon fibers, a web containing the binder is prepared, and by heating and/or pressing the web, carbon fibers can be adhered to each other. Alternatively, carbon fibers can be adhered to each other by providing a binder after making a web and thereafter heating and/or pressing the web. As a method of providing a binder, a method of applying powder-like or particle-like binder directly onto a web, a method of sprinkling a solution, a dispersion or an emulsion of binder, whose medium is water, alcohol and the like, onto a web, or a method of dipping a web in a solution, a dispersion or an emulsion of binder, as needed, squeezing the liquid, and thereafter, removing the medium by drying, can be employed. As a heating method of making a binder adhere, a method of blowing hot air to a web, a method of blowing hot air from a direction of either the surface or the back surface of a web and further passing the air through the web to the opposite side (air through method), a method of heating a web by a heater, a method of heating a web by bringing the web into contact with a high-temperature roll and the like can be employed. Further, for the purpose of enhancing the adhesion force of carbon fibers to each other or the efficiency of the heating, it is also possible to press the web before or after the above-described step of heating, or at the same time as the heating. As such a pressing method, a usual press machine performing the pressing by nipping the web with flat plates, a calender roll performing the pressing by nipping the web with a pair of rolls and the like can be used.

Further, by drawing such a web or a nonwoven fabric in a desired direction, the orientation of carbon fibers can be changed. The orientation of carbon fibers greatly influences the mechanical properties and flowability of a carbon fiber-reinforced plastic. For example, in the direction of the orientation of carbon fibers, although the strength and elastic modulus of the carbon fiber-reinforced plastic are high, the flowability is low. In a web or a nonwoven fabric, the rate of carbon fibers directed in a specified direction is high, and the carbon fibers are in a condition of being oriented. Therefore, although it exhibits a so-called “anisotropy,” by drawing such a web or a nonwoven fabric, the anisotropy can be further enhanced, or a so-called “isotropy” can be enhanced by relieving the anisotropy.

Impregnation of a matrix resin into the above-described web or nonwoven fabric is not particularly restricted, and a known method exemplified as follows can be used. For example, it is possible to form a matrix resin as a sheet such as a film or a nonwoven fabric, laminate such a sheet with a carbon fiber web or a carbon fiber nonwoven fabric and thereafter melt the matrix resin, thereby impregnating the matrix resin, as needed, by pressing. As a machine of producing a stampable sheet by such a method, a known machine such as a double belt pressing machine or an intermittent pressing machine can be used.

Further, a carbon fiber-reinforced plastic can also be made by cutting a sliver, which is one form of a carbon fiber aggregate, at an appropriate size and charging the cut sliver into a mold cavity of press molding to use it as a material for press molding. In the case of press molding, it is also possible to add a resin, a stabilizer, a flame retardant, a colorant and the like and to mold together. In such a case, when the sliver is press molded in a mold, they can be added into the carbon fiber-reinforced plastic by making them in a fibrous form and mixing with the sliver or by making them in a sheet-like form such as film or nonwoven, and laminating with the sliver.

The number average fiber length of carbon fibers contained in a carbon fiber-reinforced plastic obtained by press molding is preferably 3 mm or more. If the above-described number average fiber length of carbon fibers is shorter, because the mechanical properties of the carbon fiber-reinforced plastic become lower, such a condition is not preferred. To make the number average fiber length of carbon fibers contained in a carbon fiber-reinforced plastic 3 mm or more, it is of course done to make the number average fiber length of carbon fibers in cut pieces of a woven fabric 3 mm or more, only such a condition is insufficient, and it is important to prevent breakage of carbon fibers in the step of impregnating a matrix resin to obtain a carbon fiber-reinforced plastic and in the step of molding a carbon fiber-reinforced plastic by press molding. For example, in the case where a thermoplastic resin is impregnated as a matrix resin, it is important to heat the thermoplastic resin at a temperature of its melting point or higher and to press at a condition where the viscosity is lowered. In the case where melting the thermoplastic resin is insufficient, because the pressure applied to carbon fibers becomes non-uniform, carbon fibers applied with a high pressure break and the fiber length of carbon fibers becomes shorter. Such a condition is not preferred. Similarly, in case where a thermoplastic resin is used as a matrix resin also in molding, it is important to heat the thermoplastic resin at a temperature of its melting point or higher and to press at a condition where the viscosity is lowered. To the contrary, in case where the above-described number average fiber length of carbon fibers exceeds 50 mm, flowability of the resin deteriorates and a molded product with a desired shape may not be obtained, or only the resin flows and a portion with a low content of carbon fibers with a low strength may be generated or the flatness of the surface of a molded product may be spoiled, and such a condition is not preferred.

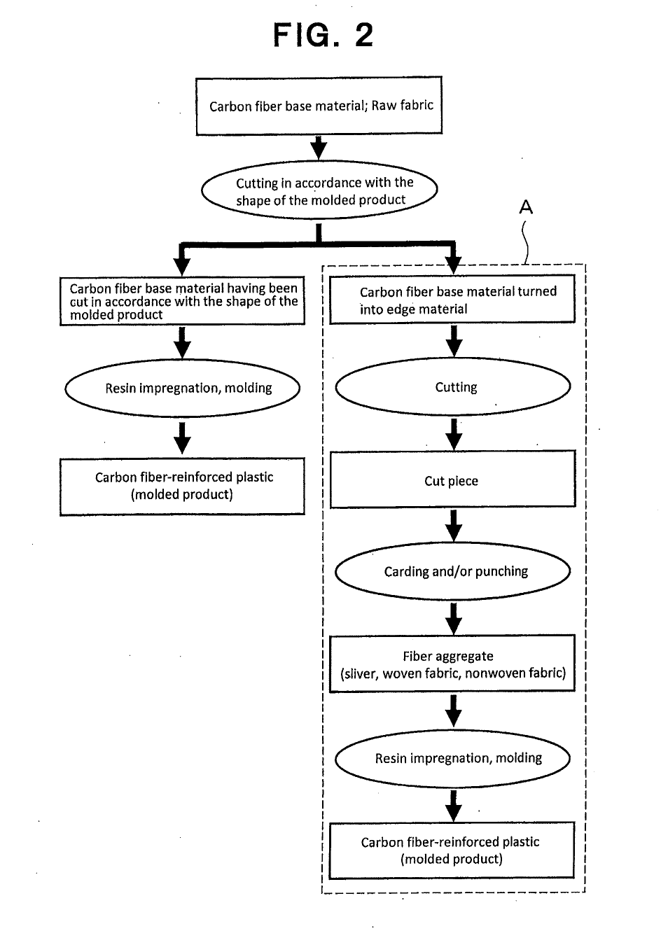

Further, as a carbon fiber base material composed of carbon fibers, an edge material is used. The edge material means, for example, a carbon fiber base material unnecessary for a preform or the like which is a residual after cutting a carbon fiber base material to make a preform or the like. Because such an edge material has been already cut to some extent, the cutting step before carding may be relatively diminished. Further, because there is no effective method to utilizing an edge material of a carbon fiber base material and it is frequently scrapped, it can be obtained inexpensively and use thereof is preferable also from the viewpoint of effective application of resources. A process flow of the method of producing a carbon fiber aggregate and a carbon fiber-reinforced plastic is shown in FIG. 2 at a simplified state.

In FIG. 2, although a process of producing a usual carbon fiber-reinforced plastic (a molded product) is also shown, a process flow part A surrounded by a dashed line exemplifies a process flow of a method for producing a carbon fiber aggregate and a carbon fiber-reinforced plastic according by using an edge material of a carbon fiber woven fabric.

### EXAMPLES

Hereinafter, our methods will be explained more concretely by examples. Methods of determining the respective properties used in these examples are as follows.

### Number Average Fiber Length of Carbon Fibers in Carbon Fiber Aggregate

In the case where a carbon fiber aggregate was a web or a nonwoven fabric, it was cut at a size of 30 cm square, in the case where a carbon fiber aggregate was a sliver, it was cut at a length of 30 cm, and case, the cut thereof was heated in an electric furnace heated at 500° C. for one hour and organic substances were burned off. 400 carbon fibers were randomly taken out from the residual carbon fibers and the fiber lengths thereof were determined, and using the values thereof, the number average fiber length of carbon fibers was determined.

### Number Average Fiber Length of Carbon Fibers in Cut Piece

A cut piece was decomposed using a pincette until it became carbon fiber bundles. In the case where a carbon fiber woven fabric is hard to be decomposed by welding or stitching, after it was heated in an electric furnace heated at 500° C. for one hour and organic substances were burned off, the residual was decomposed using a pincette until it became carbon fiber bundles. 400 carbon fibers were randomly taken out from the obtained carbon fiber bundles and the fiber lengths thereof were determined, and using the values thereof, the number average fiber length of carbon fibers was determined.

### Number Average Fiber Length of Carbon Fibers in Carbon Fiber-Reinforced Plastic

A sample of about 5 g was cut out from a molded product (a carbon fiber-reinforced plastic), after it was heated in an electric furnace heated at 500° C. for one hour and organic substances such as a matrix resin were burned off, the residual carbon fibers were dispersed in water while being careful not to be broken, and the dispersed aqueous solution was filtrated by a filter paper. Using a digital microscope having an image analysis function, 400 carbon fibers were randomly extracted from the carbon fibers left on the filter paper and the fiber lengths thereof were determined, and using the values thereof, the number average fiber length was determined.

### Flexural Strength of Carbon Fiber-Reinforced Plastic

Based on ISO178 method (1993), the flexural strength was determined at a condition of n=5.

### Percentage Content of Carbon Fibers in Carbon Fiber-Reinforced Plastic

A sample of about 2 g was cut out from a molded product of a carbon fiber-reinforced plastic, and the mass thereof was determined. Thereafter, it was heated in an electric furnace heated at 500° C. for one hour and organic substances such as a matrix resin were burned off. After cooling down to a room temperature, the mass of the residual carbon fibers was determined. The rate of the mass of the carbon fibers to the mass of the sample before being burned off with organic substances such as a matrix resin was determined, and it was defined as the percentage content of carbon fibers.

### Example 1

After a plain weave woven fabric (“C06343,” produced by Toray Industries, Inc.) made by using carbon fibers (“T300,” produced by Toray Industries, Inc., density: 1.76 g/cm³, diameter: 7 μm, number of filaments: 3000) was cut into cut pieces each at a size of 5 cm square, the cut pieces were fed into an opening machine to decompose the woven fabric, where-by a mixture of carbon fiber bundles and refined carbon fibers was obtained. The number average fiber length of carbon fibers in the cut piece was 48 mm. This mixture was fed again into the opening machine, and cotton-like carbon fibers, in which carbon fiber bundles almost do not exist, were obtained. The cotton-like carbon fibers and NYLON 6 discontinuous fibers (single fiber fineness: 1.7 dtex, cut length: 51 mm, number of crimps: 12 crests/25 mm, rate of crimp: 15%) were mixed at a mass ratio of 50:50. This mixture was fed again into the opening machine, and a mixture raw cotton composed of carbon fibers and NYLON 6 fibers was obtained.

This mixture raw cotton was fed into a carding machine having a structure as shown in FIG. 1 which has a cylinder roll with a diameter of 600 mm to form a sheet-like web composed of carbon fibers and NYLON 6 fibers. Then, the web was drawn while being narrowed in width to obtain a sliver. At that time, the rotational speed of the cylinder roll was 350 rpm, and the speed of the doffer was 15 m/min. In the obtained sliver, the number average fiber length of carbon fibers was 31 mm. In this carding step, falling off and winding onto the rolls of the carding machine of carbon fibers did not occur.

After this sliver was drawn while being twisted and further heated continuously by an infrared heater to melt NYLON 6 fibers, it was cooled and solidified, and it was cut at a length of 10 mm to obtain a material for injection molding. This material for injection molding and a NYLON 6 resin (“CM1001” produced by Toray Industries, Inc.) were mixed so that the mass ratio of carbon fibers to NYLON 6 (including NYLON 6 fibers) becomes 20:80 and the mixture was injection molded, thereby obtaining a flat plate-like molded product of a carbon fiber-reinforced plastic. The number average fiber length of carbon fibers in the obtained molded product was 0.9 mm. Further, when the flexural strength of the obtained flat plate was measured, it was 350 MPa.

### Example 2

A sliver was obtained in a manner similar to that in Example 1, other than a condition where the same carbon fiber woven fabric as that used in Example 1 was cut at a size of 1 cm square. The number average fiber length of carbon fibers in the cut piece was 9 mm. Further, in the obtained sliver, the number average fiber length of carbon fibers was 6 mm. In this carding step, although falling off of carbon fibers was observed, winding of carbon fibers onto the rolls of the carding machine did not occur.

Using the obtained sliver, a flat plate-like molded product of a carbon fiber-reinforced plastic was obtained in a manner similar to that in Example 1. The number average fiber length of carbon fibers in the obtained molded product was 0.6 mm. Further, when the flexural strength of the obtained flat plate was measured, it was 310 MPa.

### Example 3

A sliver was obtained in a manner similar to that in Example 1, other than a condition where the same carbon fiber woven fabric as that used in Example 1 was cut at a size of 20 cm square. The number average fiber length of carbon fibers in the cut piece was 18 mm. Further, in the obtained sliver, the number average fiber length of carbon fibers was 31 mm. In this carding step, falling off of carbon fibers which became shorter by being cut at the carding step and winding of carbon fibers partially onto the rolls of the carding machine were observed.

Using the obtained sliver, a flat plate-like molded product of a carbon fiber-reinforced plastic was obtained in a manner similar to that in Example 1. The number average fiber length of carbon fibers in the obtained molded product was 0.7 mm. Further, when the flexural strength of the obtained flat plate was measured, it was 330 MPa.

### Comparative Example 1

The same carbon fiber woven fabric as that used in Example 1 was used and it was cut to form cut pieces, and after they were kneaded with a NYLON 6 resin (“CM1001,” produced by Toray Industries, Inc.) by a twin-screw extruder so that the mass ratio of carbon fibers to NYLON 6 became 50:50, the mixture was extruded in a gut-like form, and it was cooled by water and cut to make pellets for injection molding. Because the cut carbon fiber woven fabric could not be stably fed into the twin-screw extruder if they were large, the carbon fiber woven fabric was fed into the twin-screw extruder after it was cut at a size of 1 cm square. The number average fiber length of carbon fibers in the cut piece was 9 mm. The obtained pellets for injection molding were injection molded in a manner similar to that in Example 1 to obtain a flat plate-like molded product of a carbon fiber-reinforced plastic. The number average fiber length of carbon fibers in the obtained molded product was 0.1 mm. Further, when the flexural strength of the obtained flat plate was measured, it was 210 MPa.

### Example 4

A web was made in a manner similar to that in Example 1 until a sheet-like web was made. The number average fiber length of carbon fibers in the web was 36 mm. The variation in areal weight (CV value) of carbon fibers in the web which was a carbon fiber aggregate was 6%, and the variation in thickness (CV Value) was 7%. Further, the critical shear deformation angle of the carbon fiber aggregate did not indicate a local maximum value within a range up to 30 degrees, and it exceeded 30 degrees.

The webs were laminated in a same direction and, further, NYLON 6 films were laminated so that the mass ratio of carbon fibers to NYLON 6 (including NYLON 6 fibers) became 30:70. The laminate of the webs and NYLON 6 films was nipped with polyimide films and further nipped with aluminum plates, and pressed at 250° C. for three minutes while being pressed by a pressing machine at a pressure of 5 MPa, and thereafter, it was cooled down to 40° C. to obtain a flat plate-like molded product of a carbon fiber-reinforced plastic. The number average fiber length of carbon fibers in the obtained molded product was 28 mm. Further, when the flexural strength of the obtained flat plate was measured, it was 410 MPa. Further, in the CFRP voids were not formed, and the appearance was excellent.

### Example 5

Using carbon fiber bundles each composed of 12000 single fibers of carbon fibers (“T700S,” produced by Toray Industries, Inc., density: 1.8, diameter: 7 μm) as reinforcing fibers and polyester yarns (“Tetron,” produced by Toray Industries, Inc., number of filaments: 24, total fineness: 56 tex) as stitch yarns, the carbon fiber bundles were arranged and laminated to form a structure of −45 degrees/90 degrees/+45 degrees/0 degree/+45 degrees/90 degrees/−45 degrees, and they were integrated by stitch yarns to make a multiaxial stitch base material. The carbon fiber bundles were arranged in the respective layers so that the arrangement density of carbon fiber bundles became 3.75/cm and the areal weight of carbon fiber bundles became 300 g/m² per two layers, and the arrangement interval of stitch yarns was set at 5 mm and the pitch of stitch was set at 5 mm. The rate of stitch yarns existing in the obtained multiaxial stitch base material was 2 wt. %. An edge material after making a preform for RTM using this multiaxial stitch base material was recycled, and it was placed on a table of an automatic cutting machine having a ultrasonic cutter capable of moving on the table in X and Y directions. Thereafter, while moving the ultrasonic cutter in X direction and Y direction at an interval of 8 cm, the edge material of the multiaxial stitch base material was cut to make cut pieces. The number average fiber length of carbon fibers contained in the cut pieces was 42 mm. A web was made in a manner similar to that in Example 4 other than a condition where cut pieces were changed to those obtained as above and carbon fibers and NYLON 6 discontinuous fibers were mixed at a mass ratio of 80:20. In this Example, by using not a carbon fiber base material itself, but an edge material thereof, the cut pieces could be obtained more efficiently and in a shorter time than those in Example 4. The number average fiber length of carbon fibers in the web was 40 mm. The variation in areal weight of carbon fibers in the web which was a carbon fiber aggregate was 8%, and the variation in thickness was 8%. Further, the critical shear deformation angle of the carbon fiber aggregate did not indicate a local maximum value within a range up to 30 degrees, and it exceeded 30 degrees.

The obtained webs were laminated in a same direction, and further, a film composed of PPS (“Torcon,” produced by Toray Industries, Inc.) was laminated so that the mass ratio of carbon fibers:PPS became 30:80. The laminate of the web and PPS film was nipped with polyimide films and further nipped with aluminum plates, and pressed at 340° C. for three minutes while being pressed by a pressing machine at a pressure of 5 MPa and, thereafter, it was cooled down to 40° C. to obtain a flat plate-like molded product of a carbon fiber-reinforced plastic. The number average fiber length of carbon fibers in the obtained molded product was 21 mm. Further, when the flexural strength of the obtained flat plate was measured, it was 340 MPa.

### Example 6

A web was made in a manner similar to that in Example 5 other than a condition where cut pieces were made by cutting an edge material of the multiaxial stitch base material after making a preform for RTM, by using a Thomson cutter mold to punch the edge material at a size of 8 cm square. In this Example, by using a Thomson cutter mold, the cutting of the edge material could be performed more efficiently and in a shorter time than those in Example 5. The number average fiber length of carbon fibers contained in the cut pieces, the number average fiber length of carbon fibers in the web, the variation in areal weight and the variation in thickness of carbon fibers in the web, and the critical shear deformation angle were the same as those in Example 5.

### Example 7

A web was made in a manner similar to that in Example 4 other than a condition where as a same carbon fiber woven fabric as that used in Example 1, a carbon fiber woven fabric with a binder, which was prepared by applying binder particles (low melting-point quaternary copolymerized NYLON particles) at 5 g/m² and welding the particles, was used to make a preform for RTM, an edge material after making the preform was recycled, the recycled edge material was cut using a Thomson cutter mold, and instead of NYLON 6 discontinuous fibers, recycled glass fibers (number average fiber length: 10 cm) were mixed at a rate in mass ration of carbon fibers 70: recycled glass fibers 30. After the webs were laminated in the same direction, the laminate was needle punched to obtain a nonwoven fabric (100 g/m²). The number average fiber length of carbon fibers in the cut pieces was 32 mm. Further, the number average fiber length of carbon fibers in the obtained nonwoven fabric was 27 mm. In the carding, in spite of using the carbon fiber woven fabric with a binder which was hard to be loosened, winding of fibers onto rolls of a carding machine did not occur, and the process passing property was good.

The variation in areal weight of carbon fibers in the carbon fiber aggregate was 7%, and the variation in thickness was 9%. Further, the critical shear deformation angle of the carbon fiber aggregate did not indicate a local maximum value within a range up to 30 degrees, and it exceeded 30 degrees.

A laminate was prepared by laminating the obtained webs and the above-described carbon fiber woven fabrics with a binder so that the webs became a core at a schematic sandwich form having a laminated structure of 2 layers of the carbon fiber woven fabrics/4 layers of the webs/2 layers of the carbon fiber woven fabrics, and by resin transfer molding (RTM), a flat plate-like molded product of a carbon fiber-reinforced plastic was obtained. Concretely, the above-described laminate was placed in a cavity of a flat plate-like mold comprising a male mold and a female mold, after closing the mold with sealing condition, the cavity was vacuum evacuated from a vacuum evacuation port so that the pressure in the cavity became a pressure of 0.08 to 0.1 MPa, and an epoxy resin, which was a matrix resin, was infused at a pressurized condition from a resin inlet port. After a predetermined time passed, the vacuum evacuation was stopped to stop the infusion of the matrix resin, and after one hour passed, took out to obtain a flat plate-like molded product of a carbon fiber-reinforced plastic. The mold was heated at 110° C. in advance before infusion of the matrix resin, and by keeping the same temperature after the injection of the resin, the matrix resin was cured. As the epoxy resin, “TR-C32” produced by Toray Industries, Inc. was used.

The number average fiber length of carbon fibers in the obtained molded product was 27 mm, and the content in weight of carbon fibers Wf in the molded product was 55 wt. %. Further, when the flexural strength of the obtained flat plate, it was 635 MPa. In RTM, because the variations in areal weight and in thickness (CV values) of the nonwoven fabric could be set to be low, in the resin impregnation, an unstable flow was not observed and a uniform resin flow was performed, and voids were not formed and a molded product excellent in appearance was obtained.

### INDUSTRIAL APPLICATIONS

Our methods can be applied to production of any carbon fiber aggregate and any carbon fiber-reinforced plastic desired with recycle of cut pieces of a carbon fiber base material.

1. A method of producing a carbon fiber aggregate:
cutting an edge material of a carbon fiber base material composed of carbon fibers to obtain a cut piece, and
forming said cut piece into a web and/or into a nonwoven fabric to obtain a carbon fiber aggregate.

2. The method according to claim 1, wherein forming into a web and/or into a nonwoven fabric is performed by carding and/or punching, and said carbon fiber aggregate has a form of a web and/or a nonwoven fabric.

3. The method according to claim 1, wherein a variation (a CV value) in areal weight of carbon fibers in said carbon fiber aggregate is less than 10%.

4. The method according to claim 1, wherein a critical shear deformation angle of said carbon fiber aggregate is 30 degrees or more.

5. The method according to claim 1, further comprising applying a binder or a tackifier to said carbon fiber base material.

6. The method according to claim 1, wherein said cut piece is refined in advance and thereafter carded and/or punched.

7. The method according to claim 1, wherein a number average fiber length of carbon fibers contained in said carbon fiber aggregate is 5 to 100 mm.

8. The method according to claim 1, wherein a number average fiber length of carbon fibers contained in said cut piece used is 25 to 100 mm.

9. The method according to claim 1, wherein said carbon fiber base material contains carbon fiber bundles, and said carbon fiber bundles are refined.

10. The method according to claim 2, further comprising adding thermoplastic resin fibers or glass fibers to said cut piece at said carding and/or punching.

11. The method according to claim 10, wherein said thermoplastic resin fibers or said glass fibers are recycled.

12. A method of producing a carbon fiber-reinforced plastic wherein a matrix resin is impregnated into a carbon fiber aggregate produced by the method according to claim 1.

13. The method according to claim 12, wherein said matrix resin is a precursor of a thermosetting resin or a thermoplastic resin, and said matrix resin is impregnated by infusion molding, resin transfer molding (RTM), vacuum-assisted resin transfer molding (VaRTM) or reaction injection molding (RIM).

14. The method according to claim 12, wherein in said infusion molding, said matrix resin is impregnated into a laminate laminated with said carbon fiber aggregate and a carbon fiber base material different from said carbon fiber aggregate in a sandwich form so that said carbon fiber aggregate becomes a core of the sandwich.

15. The method according to claim 12, wherein said matrix resin is a thermoplastic resin, and after said matrix resin is impregnated into said carbon fiber aggregate, they are injection molded.

16. The method according to claim 15, wherein a number average fiber length of carbon fibers contained in a carbon fiber-reinforced plastic obtained by injection molding is 0.2 to 25 mm.

17. The method according to claim 12, wherein said matrix resin is a thermosetting resin or a thermoplastic resin, and after said matrix resin is impregnated into said carbon fiber aggregate, they are press molded.

18. The method according to claim 12, wherein said matrix resin is a thermosetting resin or a thermoplastic resin, and said matrix resin is impregnated by press molding.

19. The method according to claim 17, wherein a number average fiber length of carbon fibers contained in a carbon fiber-reinforced plastic obtained by press molding is 3 to 50 mm.

20. The method according to claim 17, wherein in said press molding, said matrix resin is impregnated into a laminate laminated with said carbon fiber aggregate and a carbon fiber base material different from said carbon fiber aggregate in a schematic sandwich form so that said carbon fiber aggregate becomes a core of the sandwich.
